(19) United States
(12) Patent Application Publication
(10) Pub. No.: US 2013/0229077 A1
(43) Pub. Date: Sep. 5, 2013

(54) Miniature Motor and Bearing Arrangement

(71) Applicant: MULTIELECTRIC GMBH & CO. KG, Stuttgart (DE)

(72) Inventors: Dario BOCCADAMO, Stuttgart (DE); Joachim FRIEBE, Weinstadt (DE)

(73) Assignee: MultiElectric GmbH & Co. KG, Stuttgart (DE)

(21) Appl. No.: 13/776,060

(22) Filed: Feb. 25, 2013

(30) Foreign Application Priority Data
Mar. 5, 2012 (DE) 10 2012 101 825.1

(51) Int. Cl. H02K 7/08; B23K 26/22

(52) U.S. Cl. CPC H02K 7/08; B23K 26/22
USPC 310/90; 384/548; 228/101; 219/121.64

(57) ABSTRACT

Electric miniature motor comprises bearings; stationary assemblies having end faces; metallic configurations for seating the bearings are formed at the end faces of the stationary assemblies; and at least one of the bearings is a roller bearing wherein an inner ring of the roller bearing is connected by at least one welded joint to a shaft of the motor.

### FIELD OF THE INVENTION

The present invention relates to electric miniature motors and a bearing arrangement for those.

### STATE OF THE ART

Nowadays, miniature motors are used in various applications. Those include drives in home appliances, hand tools, actuators in motor vehicles and the like. The demands upon the motors are steadily increasing, including a lower noise generation besides a higher performance.

A major noise source can be the mounting of the rotor of the motor if axial and/or radial relative movements of the motor shaft can occur in the mounting positions for mounting the same. These movements are enabled by the tolerances required for fabricating the components of the motor, the reduction of which can only be obtained with a considerable cost effort.

Therefore, efforts have been made to minimize the mentioned relative movements without reducing the free movability of the shaft. Measures for achieving this object are described in EP 1 041 303 A1, DE 195 37 503 A1, DE 40 10 564 A1 and DE 10 2008 027 841 A1, for example. The solutions shown in these documents are still accompanied by a considerable effort regarding the components or the process.

The object of the present invention is to provide an electric miniature motor with a bearing system in which the bearing clearance of the shaft is limited to the clearance of an inserted roller bearing without the requirement that the individual components have to have narrow axial and radial tolerances.

It has now been found that this object can be achieved by fixing the bearing by welding, e.g. laser welding, at the shaft.

### SHORT DESCRIPTION OF THE INVENTION

The object of the present invention is an electric miniature motor, wherein metallic configurations for seating the bearings are formed at the end faces of the stationary assemblies and wherein at least one of the bearings is a roller bearing which is connected by welding, e.g. laser welding, to the shaft.

### SHORT DESCRIPTION OF THE FIGURES

FIG. 1 illustrates a longitudinal section of a miniature motor including the common assemblies according to an embodiment of the present invention;

FIG. 2 is a detailed view of the mounting according to FIG. 1 with the welded joint 2.3;

FIG. 3 illustrates a top view according to FIG. 2 with three welded joints 2.3.

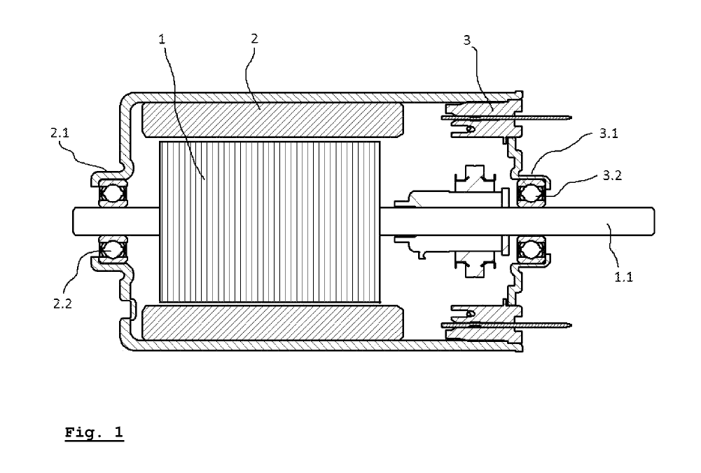

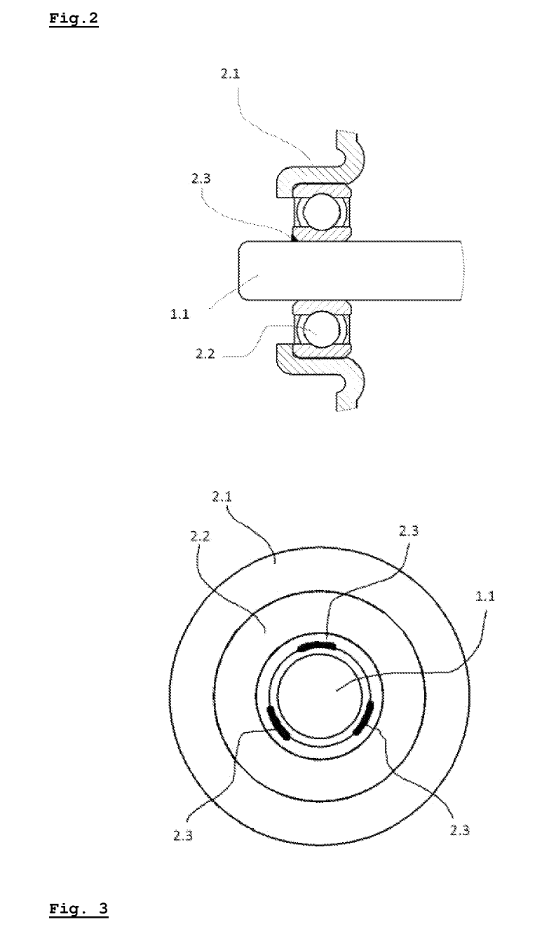

### DETAILED DESCRIPTION OF THE INVENTION

A miniature motor according to the present invention substantially comprises a rotor assembly 1, a housing assembly 2 and a power transmission assembly 3. The components of these assemblies are sufficiently known from conventional motors and are thus only described here insofar as required for understanding the invention.

The housing assembly 2 and the power transmission assembly 3 have cylindrical configurations 2.1 and 3.1, respectively, receiving the bearings 2.2 and 3.2, respectively, in which in turn the shaft 1.1 of the rotor assembly 1 is mounted.

In the further description, it is exemplarily assumed that the bearing 3.2 is fixed in the cylindrical seat 3.1 and that the shaft 1.1 is axially displaceable in this bearing. This bearing can be both a roller bearing and a sleeve bearing. Further, it is assumed that the bearing 2.2 is a roller bearing, e.g. a ball bearing, which is fixed in the associated configuration 2.1 and wherein the shaft 1.1 can be axially displaced.

Using suitable means and devices, respectively, the rotor assembly 1 is brought into the desired position with respect to the housing assembly 2, and the inner ring of the roller bearing 2.2 is then welded to the shaft 1.1, e.g. by a laser beam. The welding 2.3 can be formed point-like or corrugated, at one or several positions (partially) or over the entire circumference of the shaft 1.1.

Because the roller bearing was already fixed in the configuration 2.1 with the outer ring and because after welding the inner ring to the shaft the rotor assembly is also fixed, the remaining axial and radial clearance of the rotor assembly is exclusively determined by the accuracy of the roller bearing.

A partial welded joint 2.3 achieves a specific resistance against axial forces acting upon the bearing 2.2. It is thus also possible to satisfy different requirements regarding these forces depending upon the use conditions of the motor by the number of welded joints 2.3 and their configuration.

1. Electric miniature motor, comprising:
a) bearings;
b) stationary assemblies having end faces;
c) metallic configurations for seating the bearings are formed at the end faces of the stationary assemblies; and
d) at least one of the bearings is a roller bearing wherein an inner ring of the roller bearing is connected by at least one welded joint to a shaft of the motor.

2. Electric miniature motor according to claim 1, wherein the welded joint is formed point-like or as a corrugation between the inner ring of the roller bearing and the shaft.

3. Electric miniature motor according to claim 1, wherein the welding between the ball bearing and the shaft occurs at several positions.

4. Electric miniature motor according to claim 1, wherein the welded joint extends over an entire circumferential line of the shaft.

5. Bearing arrangement for an electric miniature motor, comprising:
a) a metallic configuration for seating a roller bearing at an end face of stationary assemblies of the miniature motor;
b) a roller bearing fixed in the configuration;
c) a shaft seated in the roller bearing; and
d) at least one welded joint connecting the roller bearing to the shaft.

6. Method for fabricating an electric miniature motor, comprising:
a) fixing a roller bearing within a configuration at an end face of stationary assemblies of the miniature motor;
b) positioning a shaft of the rotor assembly of the miniature motor within the roller bearing;
c) welding the inner ring of the roller bearing to the shaft.

7. Method according to claim 6, wherein the welding of the inner ring of the roller bearing to the shaft occurs by laser welding.

8. Method according to claim 6, wherein the welding is performed at a front side at an end face of the stationary assemblies of the miniature motor.

9. Method according to one of claim 6, wherein the welding is performed in a point-like fashion.

10. Method according to one of claim 6, wherein the welding is performed in a corrugated fashion.
